(19) United States
(12) Patent Application Publication
(10) Pub. No.: US 2016/0065487 A1
(43) Pub. Date: Mar. 3, 2016

(54) ELECTRONIC APPARATUS, METHOD, AND STORAGE MEDIUM

(71) Applicant: Kabushiki Kaisha Toshiba, Tokyo (JP)

(72) Inventor: Kouetsu Wada, Nishitama Tokyo (JP)

(21) Appl. No.: 14/677,786

(22) Filed: Apr. 2, 2015

(30) Foreign Application Priority Data
Sep. 3, 2014 (JP) 2014-179055

(51) Int. Cl. H04L 12/917; H04L 29/08

(52) U.S. Cl. CPC H04L 47/76; H04L 67/22

(57) ABSTRACT

In one embodiment, an electronic device includes circuitry configured to acquire usage information indicative of use of a device in an external device and decide a recommended device and/or a recommended configuration of the external device based on the usage information.

### CROSS-REFERENCE TO RELATED APPLICATIONS

This application is based upon and claims the benefit of priority from Japanese Patent Application No. 2014-179055, filed Sep. 3, 2014, the entire contents of which are incorporated herein by reference.

### FIELD

Embodiments described herein relate generally to an electronic apparatus, a method, and a storage medium.

### BACKGROUND

Recently, in various companies, etc., a terminal management system for managing a plurality of terminal devices (hereinafter referred to as client terminals) such as personal computers used in the companies has been utilized.

In the terminal management system, information on IT resources (resources of hardware, software, etc.) that each of the client terminals has (hereinafter referred to as inventory information) can be collected from each of the client terminals, and it is possible to manage the IT resources in a company efficiently, and reduce the management cost.

More specifically, in such a terminal management system, distributions of security patches and application programs to the client terminals, working hours management using the operating time of the client terminals, management of license information on software, etc., can be performed.

Note that the inventory information collected in the terminal management system includes, for example, information indicating use of a client terminal by a user.

As described above, in the terminal management system, it is possible to ascertain the use of each of the client terminals by collecting the inventory information.

Here, in order to realize efficient IT resource management (operation) in a company, etc., a suitable client terminal should preferably be used in terms of the use by the user.

However, by only collecting the inventory information from each of the client terminals, it is not possible to determine whether (configurations of) the respective client terminals are suitable in terms of the use, and efficient IT resource management may not be realized.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an illustration showing an example of a network configuration of a terminal management system including a server apparatus according to an embodiment;

FIG. 2 is an illustration showing an example of a system configuration of a client terminal;

FIG. 3 is an illustration showing an example of a system configuration of the server apparatus;

FIG. 4 is a block diagram showing an example of a functional configuration of the server apparatus according to the embodiment; and

FIG. 5 is a flowchart showing an example of a processing procedure of the server apparatus according to the embodiment.

### DETAILED DESCRIPTION

Various embodiments will be described hereinafter with reference to the accompanying drawings.

In general, according to one embodiment, an electronic device includes circuitry configured to acquire usage information indicative use of a device in an external device and decide a recommended device and/or a recommended configuration of the external device based on the usage information.

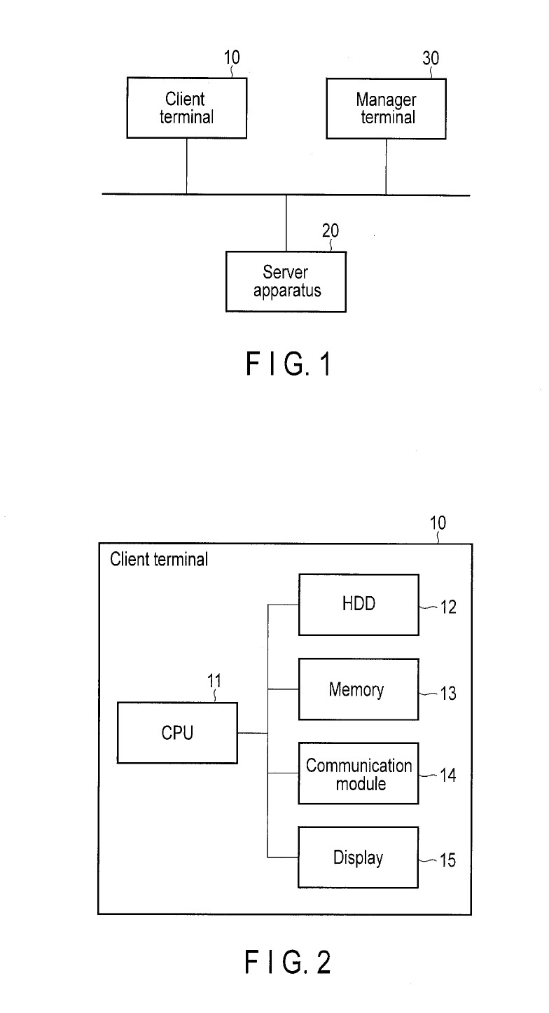

FIG. 1 shows an example of a network structure of a terminal management system (a network system) including a server apparatus according to the embodiment. As shown in FIG. 1, the terminal management system includes a client terminal 10, a server apparatus 20, a manager terminal 30, etc., which are connected such that they can communicate with each other via a network.

The client terminal 10 is a terminal device such as a personal computer used by a user in a company, for example. Although a plurality of client terminals 10 exist in the terminal management system, only one of them is shown in FIG. 1 for convenience.

The server apparatus 20 is an electronic apparatus used for managing the client terminals 10 connected to be able to communicate with the server apparatus 20. Note that the server apparatus 20 can collect information on IT resources (for example, resources of hardware, software, etc.) that each of the client terminals 10 has (hereinafter referred to as inventory information) from each of the client terminals 10.

The manager terminal 30 is a terminal device used by a manager of the terminal management system and is, for example, a personal computer. By running software for the manager on the manager terminal 30, the manager can make various settings, etc., for managing the client terminals 10.

FIG. 2 shows an example of a system configuration of the client terminal 10 included in the terminal management system shown in FIG. 1. As shown in FIG. 2, the client terminal 10 includes a CPU 11, an HDD (a disk storage) 12, a memory 13, a communication module 14, a display 15, etc.

The CPU 11 is a processor which controls operation of each component within the client terminal 10. The processor includes at least one circuitry. The CPU 11 executes various kinds of software loaded from the HDD 12, which is a storage device, to the memory 13. Software executed by the CPU 11 in this manner includes, for example, an operating system (OS).

The communication module 14 is a module configured to execute communication with the server apparatus 20, for example.

The display 15 is a display which displays a display screen, etc., according to the software executed by the CPU 11 described above when, for example, the user uses the client terminal 10. The display 15 includes a liquid crystal display (LCD), etc.

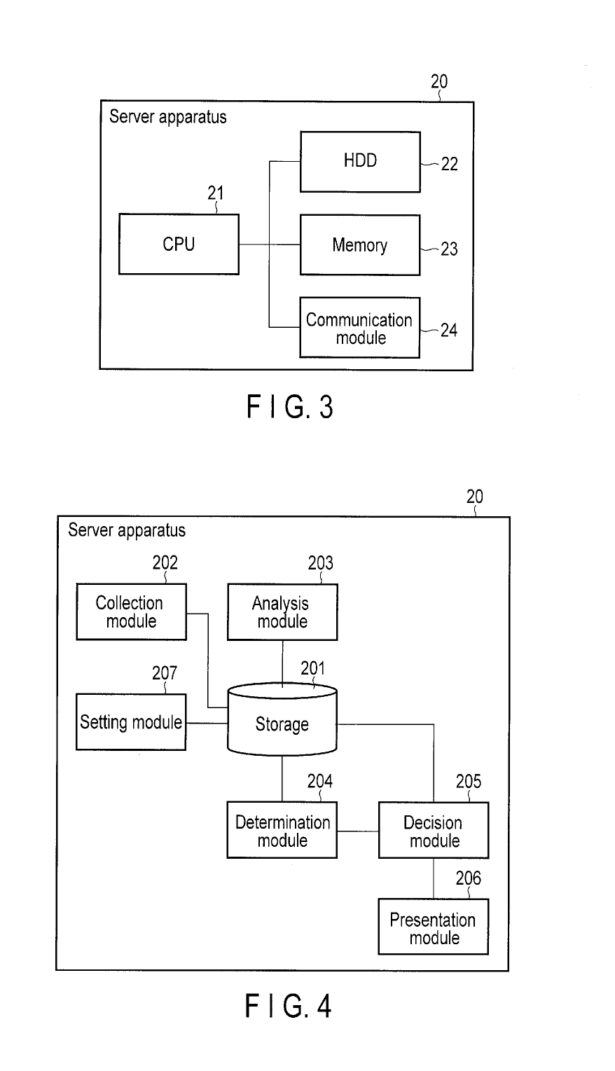

FIG. 3 shows an example of a system configuration of the server apparatus 20 included in the terminal management system shown in FIG. 1. As shown in FIG. 3, the server apparatus 20 includes a CPU 21, an HDD 22, a memory 23, a communication module 24, etc.

The CPU 21 is a processor which controls operation of each component within the server apparatus 20. The processor includes at least one circuitry. The CPU 21 executes various kinds of software loaded from the HDD 22, which is a storage device, to the memory 23. Software executed by the CPU 21 in this manner includes, for example, an operating system (OS).

The communication module 24 is a module configured to execute communication with, for example, an external device including the client terminal 10, the manager terminal 30, etc.

Here, the system configurations of the client terminal 10 and the server apparatus 20 provided in the terminal management system have been described with reference to FIGS. 2 and 3. Since a system configuration of the manager terminal 30 is similar to the system configuration of the client terminal 10 described with reference to FIG. 2, a detailed explanation of the system configuration of the manager terminal 30 will be omitted.

FIG. 4 is a block diagram showing an example of a functional configuration of the server apparatus 20 according to the embodiment.

As shown in FIG. 4, the server apparatus 20 includes a storage (a database) 201, a collection module 202, an analysis module 203, a determination module 204, a decision module 205, a presentation module 206, and a setting module 207. These modules 202 to 207 are functional modules realized by software. Alternatively, the modules 202 to 207 may be realized by hardware or by a combination of hardware and software.

In the storage 201, recommended configuration decision information used for deciding a configuration (hereinafter referred to as a recommended configuration) of a device suitable in terms of use of the client terminal 10, which will be described later, is stored in advance.

The collection module 202 collects inventory information on IT resources that the client terminal 10 (that is, the external device) connected to be able to communicate with the server apparatus 20 has (hereinafter referred to as inventory information of the client terminal 10) from the client terminal 10. The inventory information of the client terminal 10 includes, for example, identification information for identifying the client terminal 10 (hereinafter referred to as a client terminal ID) and use information indicating the use of the client terminal 10. The use information included in the inventory information includes the type of CPU 11 (hereinafter referred to as the CPU type) provided in the client terminal 10, the rate of use of the CPU 11 (hereinafter referred to as the rate of CPU use), the capacity of the memory 13 (hereinafter referred to as the memory capacity), the rate of use of the memory 13 (hereinafter referred to as the rate of memory use), the capacity of the HDD 12 (hereinafter referred to as the disk capacity), the free space of the HDD 12 (hereinafter referred to as the free disk space), etc. Note that the CPU type, the memory capacity, and the disk capacity are information held in advance inside the client terminal 10, for example. The rate of CPU use, the rate of memory use, and the free disk space are information acquired from the operating system, etc., which runs on the client terminal 10. Further, although the details are omitted, the inventory information includes information on software which runs on the client terminal 10 (SW inventory information), in addition to information on hardware (HW inventory information) that the client terminal 10 has such as the above-described CPU type.

The above-described inventory information is collected from each of the client terminals 10 managed in the terminal management system. The inventory information collected from each of the client terminals 10 in this manner is stored in the storage 201 to be associated with, for example, a date and time when the inventory information in question was collected.

Here, collection processing of the inventory information by the collection module 202 is executed at preset intervals (hereinafter referred to as collection intervals). More specifically, the manager can designate the collection intervals by operating the manager terminal 30, for example. The collection intervals designated by the manager in this manner are transmitted to each of the client terminals 10 by way of the server apparatus 20, for example, as a command for collecting (acquiring) the inventory information. The collection intervals of the inventory information in the terminal management system are thereby set.

In this case, dedicated software (client SW) runs on each of the client terminals 10, and the client terminals 10 transmit the inventory information of the client terminals 10 at the collection intervals which have been set. The collection module 202 can thereby collect (use information included in) the inventory information from each of the client terminals 10 at the set collection intervals.

The analysis module 203 analyzes the use information included in the inventory information stored in the storage 201 (that is, the inventory information collected by the collection module 202). The analysis module 203 thereby calculates the average rate of use of the CPU 11 (hereinafter referred to as the average rate of CPU use) and the average rate of use of the memory 13 (hereinafter referred to as the average rate of memory use) provided in each of the client terminals 10. The average rate of CPU use and the average rate of memory use calculated by the analysis module 203 are stored (written) in the storage 201 as the above-described use information.

The determination module 204 determines, on the basis of use of the client terminal 10 indicated by the use information included in the inventory information stored in the storage 201, whether a configuration (specs, etc.,) of the client terminal 10 is suitable in terms of this use. Note that set values, which will be described later, are used in the above determination processing performed by the determination module 204.

The decision module 205 decides (determines) a recommended configuration of each of the client terminals 10 (that is, a configuration of a device suitable in terms of the use of each of the client terminals 10), on the basis of a result of determination by the determination module 204 and the recommended configuration decision information stored in the storage 201.

The presentation module 206 executes processing for presenting the recommended configuration decided by the decision module 205 to the manager, for example. In this case, the presentation module 206 transmits (information indicating) the recommended configuration to the manager terminal 30 via the communication module 24. The recommended configuration is thereby displayed on the manager terminal 30.

The setting module 207 sets the set values used in the determination processing performed by the determination module 204 described above, in accordance with, for example, an operation of the manager on the manager terminal 30. More specifically, in the manager terminal 30, a setting UI for designating the set values is provided to the manager. The set values designated by the manager via such a setting UI are transmitted to the server apparatus 20 from the manager terminal 30. When the set values transmitted from the manager terminal 30 are received on the side of the server apparatus 20, the setting module 207 stores (sets) these set values in the storage 201.

The set values set by the setting module 207 include a recommended rate of use of the CPU (hereinafter referred to as the recommended rate of CPU use), a recommended rate of use of the memory (hereinafter referred to as the recommended rate of memory use), and recommended free space of the disk storage (hereinafter referred to as the recommended free disk space) in the client terminal 10 managed in the terminal management system. If different operating systems run on the respective client terminals 10 managed in the terminal management system, the recommended free disk space may be set, for example, for each of the operating systems.

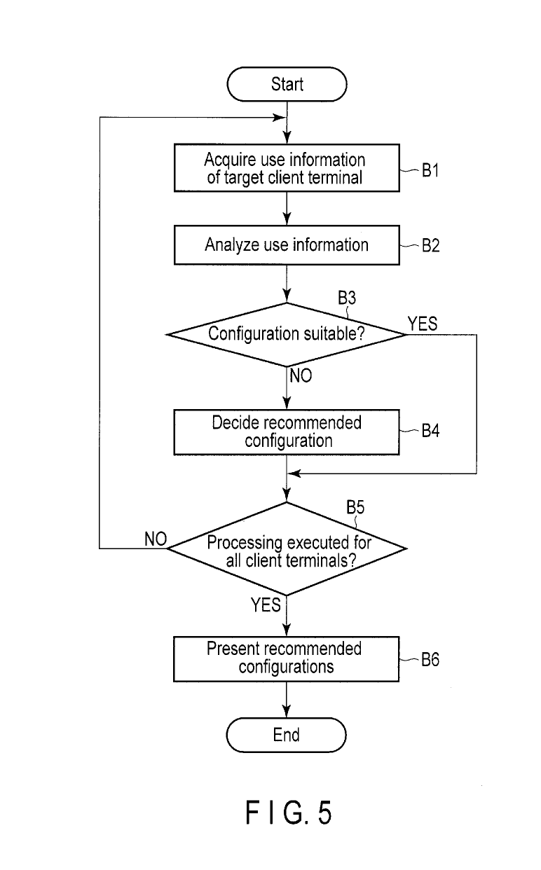

Next, with reference to the flowchart of FIG. 5, an example of a processing procedure of the server apparatus 20 according to the present embodiment in presenting the above-described recommended configuration will be described. The processing shown in FIG. 5 is executed, for example, when a recommended configuration is instructed to be presented by the manager who operates the manager terminal 30. Note that the processing shown in FIG. 5 may be executed at regular time intervals, for example.

Here, it is assumed that in the storage 201, past inventory information collected from each of the client terminals 10 at the collection intervals which have been set as described above is stored (accumulated) in association with a date and time when the inventory information in question was collected.

The inventory information stored in the storage 201 includes a client terminal ID for identifying the target client terminal 10, and use information including the CPU type, the rate of CPU use, the memory capacity, the rate of memory use, the disk capacity, and the free disk space.

Here, in the present embodiment, processing of blocks B1 to B4 described below is executed for each of the client terminals 10 managed in the terminal management system. In the following, a client terminal 10 for which the processing of blocks B1 to B4 is executed will be referred to as a target client terminal 10.

Firstly, the analysis module 203 acquires use information of the target client terminal 10 from the storage 201 (block B1). In this case, the analysis module 203 acquires inventory information which is associated with a date and time corresponding to a period set by a manager, for example, in advance. The inventory information acquired by the analysis module 203 includes a client terminal ID for identifying the target client terminal 10. In other words, the analysis module 203 acquires the inventory information collected from the target client terminal 10 during a preset period. The analysis module 203 acquires use information included in the inventory information obtained in this way as the use information of the target client terminal 10. As the preset period, a period of, for example, the last one week or month from the present is set.

Next, the analysis module 203 analyzes the acquired use information of the target client terminal 10 (block B2).

The analysis module 203 thereby calculates the average rate of CPU use and the average rate of memory use of the target client terminal 10. Note that the average rate of CPU use of the target client terminal 10 calculated by the analysis module 203 is the average value of the rates of CPU use included in (items of) the use information of the target client terminal 10. Also, the average rate of memory use calculated by the analysis module 203 is the average value of the rates of memory use included in (items of) the use information of the target client terminal 10.

The average rate of CPU use and the average rate of memory use calculated by the analysis module 203 in this way are written in the storage 201 as the use information of the target client terminal 10. In the following descriptions, the average rate of CPU use and the average rate of memory use calculated by the analysis module 203 are items which are included in (the use of the target client terminal 10 indicated by) the use information of the target client terminal 10.

Next, the determination module 204 determines whether a configuration of the target client terminal 10 is suitable in terms of the use, on the basis of (the use of the target client terminal 10 indicated by) the use information of the target client terminal 10 (block B3).

The processing of block B3 will be specifically described. In block 33, the determination module 204 compares the average rate of CPU use included in the use information of the target client terminal 10 with the recommended rate of CPU use included in set values stored in the storage 201, thereby determining whether the average rate of CPU use exceeds the recommended rate of CPU use. When the average rate of CPU use is determined as exceeding the recommended rate of CPU use, the determination module 204 determines that the configuration of the target client terminal 10 is not suitable in terms of the use.

Similarly, the determination module 204 compares the average rate of memory use included in the use information of the target client terminal 10 with the recommended rate of memory use included in the set values stored in the storage 201, thereby determining whether the average rate of memory use exceeds the recommended rate of memory use. When the average rate of memory use is determined as exceeding the recommended rate of memory use, the determination module 204 determines that the configuration of the target client terminal 10 is not suitable in terms of the use.

Further, the determination module 204 compares the free disk space included in the use information of the target client terminal 10 with the recommended free disk space included in the set values stored in the storage 201, thereby determining whether the free disk space is less than the recommended free disk space. When it is determined that the free disk space is less than the recommended free disk space, the determination module 204 determines that the configuration of the target client terminal 10 is not suitable in terms of the use. Further, if the recommended free disk space is set for each operating system as described above, the determination processing is executed by using the recommended free disk space set for the operating system which runs on the target client terminal 10. The (type of) operating system which runs on the target client terminal 10 may be managed in, for example, the server apparatus 20 in advance, or specified by the inventory information (SW inventory information) of the target client terminal 10.

That is, in block B3, processing of comparison between the use of the target client terminal 10 indicated by the use information of the target client terminal 10 (that is, the average rate of CPU use, the average rate of memory use, and the free disk space) and the set values (the recommended rate of CPU use, the recommended rate of memory use, and the recommended free disk space) is executed. In this way, when the use of the target client terminal 10 (that is, at least one of the average rate of CPU use, the average rate of memory use, and the free disk space) does not meet the above condition, it is determined that the configuration of the target client terminal 10 is not suitable in terms of the use. Conversely, when the use of the target client terminal 10 (that is, all of the average rate of CPU use, the average rate of memory use, and the free disk space) meets the condition, it is determined that the configuration of the target client terminal 10 is suitable in terms of the use.

When it is determined that the configuration of the target client terminal 10 is not suitable in terms of the use (NO in block B3), the decision module 205 decides a recommended configuration to be presented (that is, a configuration of a device suitable in terms of the use of the target client terminal 10), on the basis of recommended configuration decision information stored in the storage 201 (block B4). Note that the recommended configuration decision information stored in the storage 201 includes a CPU performance table, etc., containing numerical values representing the performance of a plurality of CPUs, for example, (hereinafter referred to as CPU performance values).

The processing of block B4 will now be specifically described. Firstly, when it is determined that the average rate of CPU use exceeds the recommended rate of CPU use in the processing of block B3 described above, the decision module 205 acquires a CPU performance value of the CPU 11 provided in the target client terminal 10 (that is, the CPU type included in the use information of the target client terminal 10) from the above-described CPU performance table. The decision module 205 calculates a CPU performance value necessary for ensuring the rate of CPU use in the target client terminal 10 to be less than or equal to the recommended rate of CPU use (that is, for achieving the recommended rate of CPU use), on the basis of the acquired CPU performance value of the CPU 11 and the average rate of CPU use calculated by the analysis module 203. In this way, the decision module 205 decides the type of CPU having the performance which exceeds at least the calculated CPU performance value as the recommended configuration.

Here, it has been described that the recommended configuration decision information (the CPU performance table) used for deciding the type of CPU (that is, a recommended configuration) necessary for ensuring the rate of CPU use in the target client terminal 10 to be less than or equal to the recommended rate of CPU use as described above is stored in (the storage 201 of) the server apparatus 20. However, the recommended configuration decision information may be acquired from an external device or the like when the processing of block B4 is executed.

Also, when it is determined that the average rate of memory use exceeds the recommended rate of memory use in the processing of block B3, the decision module 205 decides a recommended configuration on the basis of a capacity of the memory 13 provided in the target client terminal 10 (that is, the memory capacity included in the use information of the target client terminal 10), the average rate of memory use, and the recommended rate of memory use. In this case, the decision module 205 decides the memory capacity necessary for ensuring the rate of memory use in the target client terminal 10 to be less than or equal to the recommended rate of memory use (that is, for achieving the recommended rate of memory use) as the recommended configuration. More specifically, a case where the capacity of a memory provided in the target client terminal 10 is 1 GB, the recommended rate of memory use is less than or equal to 80%/hour, and the current average rate of memory use is 95%/hour is assumed. In this case, the memory capacity must be increased by 15% or more in order to achieve the recommended rate of memory use in the target client terminal 10. Thus, the decision module 205 calculates that the memory capacity necessary for achieving the recommended rate of memory use is 1.15 GB. In this way, the decision module 205 decides the calculated memory capacity of 1.15 GB as the recommended configuration.

Further, when it is determined that the free disk space is less than the recommended free disk space in the processing of block B3, the decision module 205 decides a recommended configuration on the basis of a capacity of the HDD 12 (disk storage) provided in the target client terminal 10 and free space of the HDD 12 (that is, the disk capacity and free disk space included in the use information of the target client terminal 10), and also the recommended free disk space. In this case, the decision module 205 decides a capacity of a disk storage necessary for ensuring the free disk space in the target client terminal 10 to be greater than or equal to the recommended free disk space (that is, for achieving the recommended free disk space) as the recommended configuration. More specifically, by adding the recommended free disk space to a currently used disk space which is calculated based on the disk capacity and the free disk space included in the use information of the target client terminal 10, a capacity of a disk storage necessary for achieving the recommended free disk space is calculated. In this way, the decision module 205 decides the calculated disk storage capacity as the recommended configuration.

Meanwhile, when it is determined that the configuration of the target client terminal 10 is suitable in terms of the use (YES in block B3), the processing of block B4 is not executed.

Then, it is determined whether the above processing of blocks B1 to B4 is executed for all of the client terminals 10 managed in the terminal management system (block B5).

If it is determined that the processing is not executed for all of the client terminals 10 (NO in block B5), the procedure is returned to block B1 and the processing is repeated. In this case, a client terminal 10 for which the processing is not executed is treated as a target client terminal 10, and the processing of blocks B1 to B4 is executed.

By repeating the processing in this way, a recommended configuration is decided for each of the client terminals 10 determined as having an unsuitable configuration in terms of the use in block B3.

Meanwhile, when it is determined that the processing is executed for all of the client terminals 10 (YES in block B5), the presentation module 206 presents recommended configurations decided in block B4 (that is, recommended configurations for the respective client terminals 10 determined as having unsuitable configurations in terms of the use) to, for example, the manager (block B6). In this case, the presentation module 206 transmits (information indicating) the recommended configurations for the respective client terminals 10 to the manager terminal 30. In this way, in the manager terminal 30, the recommended configurations for the respective client terminals 10 are displayed.

At this time, together with the recommended configurations for the respective client terminals 10 (that is, the CPU type, the memory capacity, and the disk capacity), the current configurations of the client terminals 10 (that is, the CPU type, the memory capacity, the disk capacity, etc., included in the use information of each of these client terminals 10) may be presented concurrently.

Further, a recommended configuration for a client terminal 10 determined as having an unsuitable configuration in terms of the use may be presented in different ways according to (degree of) a difference between the use (the average rate of CPU use, the average rate of memory use, and the free disk space) of the client terminal 10 indicated by the use information of the client terminal 10 and the set values. More specifically, when use of the client terminal 10 greatly differs from the set values, a recommended configuration of the client terminal 10 may be presented in such a way that the manager can easily ascertain (for example, in the form of warning) that degree that the configuration of the client terminal 10 should be changed is high.

Furthermore, for a client terminal 10 determined as having a suitable configuration in terms of the use, information that the configuration is suitable in this use may be presented to the manager.

In the present embodiment, by executing such processing, it becomes possible to present a recommended configuration of a client terminal 10 whose configuration is not suitable in terms of the use to the manager.

It has been described that a recommended configuration for the client terminal 10 is presented to the manager (i.e., displayed in the manager terminal 30). However, a structure in which the recommended configuration is presented to a user who uses the client terminal 10 by displaying it in the client terminal 10 may alternatively be adopted.

Further, it has been described that a CPU type, a memory capacity, or a disk capacity, for example, which has been decided as a recommended configuration of the client terminal 10, is presented. However, it is also possible to cause the server apparatus 20 to search for a product corresponding to the CPU type, the memory capacity, or the disk capacity which has been decided as the recommended configuration through the Internet, etc., and have the searched product presented as the recommended configuration. Furthermore, in searching for products, by acquiring prices (information) of those products, a product whose price is low may be presented preferentially from among the searched products.

Also, by specifying software (for example, various application programs, etc.) which runs on the client terminal 10, on the basis of inventory information stored in the storage 201 (here, SW inventory information concerning software), of the recommended configurations of the client terminal 10, only the recommended configuration which complies with an operation recommended environment of that software may be presented.

Referring to FIG. 5, for convenience of the description, it has been described that the processing of block B2 (that is, analysis processing by the analysis module 203) is executed as a series of processing when the recommended configuration is presented. However, the analysis processing may be executed in advance when, for example, the inventory information is collected from each of the client terminals 10 managed in the terminal management system. Alternatively, the analysis processing may be executed in advance during, for example, a period of time when the client terminals 10 are not so busy (that is, a period of time when a load to the server apparatus 20 is light).

Also, referring to FIG. 5, it has been described that the processing of blocks B1 to B4 is executed for all of the client terminals 10 managed in the terminal management system. However, it is possible to have the processing of blocks B1 to B4 performed for a client terminal 10 designated in accordance with an operation on the manager terminal 30 by the manager, for example, and have a recommended configuration of the client terminal 10 presented.

Further, in the present embodiment, while it has been described that the average rate of CPU use and the average rate of memory use are calculated by the analysis module 203 included in the server apparatus 20, the average rate of CPU use and the average rate of memory use may be calculated at the side of the client terminal 10. In this case, since (the collection module 202 included in) the server apparatus 20 can collect (the inventory information including) the use information containing the average rate of CPU use and the average rate of memory use, the above-mentioned analysis processing by the analysis module 203 may be omitted.

In the present embodiment described above, use information indicating use of an external device such as the client terminal 10 is acquired, and on the basis of the use indicated by the acquired use information, a configuration of a device suitable in terms of this use is presented.

More specifically, in the present embodiment, when it is determined that the rate of use of the CPU 11 provided in the client terminal 10 exceeds the recommended rate of CPU use, the CPU type (operating frequency) necessary for ensuring the rate of CPU use in the client terminal 10 to be less than or equal to the recommended rate of CPU use is presented.

Further, in the present embodiment, when it is determined that the rate of use of the memory 13 provided in the client terminal 10 exceeds the recommended rate of memory use, the memory capacity necessary for ensuring the rate of memory use in the client terminal 10 to be less than or equal to the recommended rate of memory use is presented.

Furthermore, in the present embodiment, when it is determined that free space of the disk storage (HDD 12) provided in the client terminal 10 is less than the recommended free disk space, a capacity of the disk storage necessary for ensuring the free space of the disk storage in the client terminal 10 to be greater than or equal to the recommended free disk space is presented.

In the present embodiment, by virtue of the above structure, the manager, for example, can easily ascertain a configuration of a device suitable in terms of use and apply the configuration of the device to the client terminal 10 (that is, change the client terminal 10 to have a configuration suitable in terms of the use). Accordingly, it becomes possible to assist realization of efficient IT resource management (operation) in a company, etc.

Note that in the present embodiment, when it is determined that the rate of use of the CPU 11 provided in the client terminal 10 exceeds the recommended rate of CPU use, for example, it has been described that the CPU type necessary for ensuring the rate of CPU use in the client terminal 10 to be less than or equal to the recommended rate of CPU use is presented. However, for example, when the rate of use of the CPU 11 is below the recommended rate of CPU use by a predetermined value, it is also possible to present (notify) the fact that the performance of the client terminal 10 is too high. In the above, explanation was provided for the CPU 11 provided in the client terminal 10, but the memory 13 or the HDD 12 (the disk storage) is dealt with in the same way.

In the present embodiment, it has been mainly described that a configuration of a device suitable in terms of use of the client terminal 10, such as the type of CPU, memory capacity, and the free disk space, is presented. However, the device itself suitable in terms of the use may be presented.

Also, in the present embodiment, by setting the recommended rate of CPU use, the recommended rate of memory use, and the recommended free disk space, in accordance with an operation on the manager terminal 30 by the manager, for example, displaying a device intended by the manager or a configuration of the device is enabled.

Further, in the present embodiment, by setting the recommended free disk space for each type of operating system which runs on the client terminal 10, even in a case where, for example, different operating systems run on the respective client terminals 10 used in a company, it becomes possible to present a suitable free disk space according to the corresponding operating system.

Further, in the present embodiment, by searching for a product which corresponds to a device or a configuration of a device suitable in terms of use, and presenting the searched product, the manager can more specifically recognize the device or the configuration of the device suitable in terms of the use. Also, in the present embodiment, it becomes possible to present a product whose price is low preferentially from among the products searched in this way in consideration of the cost of the IT resource management (operation).

Furthermore, in the present embodiment, by presenting a device or a configuration of the device suitable in terms of use on the basis of a recommended operating environment of software (for example, an application program) which runs on the client terminal 10, when the client terminal 10 is replaced with a device or changed to have a configuration that is suitable in terms of the use, for example, it becomes possible to avoid a situation in which a trouble occurs in the operation of the software.

Note that, in the present embodiment, it has been mainly described that the average rate of CPU use and the average rate of memory use are used as the rate of CPU use and the rate of memory use for deciding the recommended configurations. However, the maximum rate of CPU use and the maximum rate of memory use, etc., may be used instead of the average rate of CPU use and the average rate of memory use.

In the present embodiment, it has been described that a recommended configuration regarding a hardware configuration in the main of the client terminal 10 is presented. However, it is also possible to specify software which runs on the client terminal 10 based on the above-described SW inventory information (the use information of the software), and present a certain type of software from among other types of software having the object similar to that of the specified software, for example, which is suitable in terms of the current specs (for example, the CPU type, memory capacity, and disk capacity) of the client terminal 10 as a recommended configuration. That is, the present embodiment may be applied to a case where a software configuration suitable in terms of use is presented on the basis of the use of the client terminal 10.

Further, in the present embodiment, it has been described that the server apparatus 20 presents a recommended configuration on the basis of use of the client terminal 10 (an external device) (i.e., a device or a configuration of the device suitable in terms of the use) to the manager via the manager terminal 30. However, an electronic apparatus, such as the client terminal 10, may acquire use information indicating use of the electronic apparatus, and present a recommended configuration based on the use to the user by displaying it on a screen of the electronic device. That is, the present embodiment can be realized not by the above-described terminal management system as shown in FIG. 1, but by a single electronic apparatus such as the client terminal 10.

Further, in the present embodiment, it has been described that the client terminals 10 and the manager terminal 30 are different apparatuses. However, one of the client terminals 10 may be used as a manager terminal. That is, the manager terminal 30 in the present embodiment may be any kind of terminal device as long as the software for the manager described above can run.

Since the processing of the present embodiment can be realized by a computer program (for example, server SW), it is possible to easily realize an advantage similar to that of the present embodiment by installing a computer program on a computer by way of a computer-readable storage medium containing the computer program, and executing this computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
circuitry configured to:
acquire usage information indicative of use of a device in an external device; and
decide a recommended device and/or a recommended configuration of the external device based on the usage information.

2. The apparatus of claim 1, wherein
the external device is connected to communicate with the electronic apparatus, and
the circuitry further configured to acquire usage information indicative of use of the device, collected from the external device.

3. The apparatus of claim 2, wherein
the external device comprises a CPU;
the circuitry is further configured to:
acquire usage information comprising a first rate of the usage of the CPU in the external device;
determine whether the first rate of the usage included in the acquired usage information exceeds a recommended first rate of usage; and
decide a class of CPU necessary for ensuring the first rate of usage of the CPU in the external device to be less than or equal to the recommended first rate of usage when it is determined that the first rate of usage exceeds the recommended first rate of usage.

4. The apparatus of claim 3, wherein the circuitry is further configured to set the recommended first rate of usage in accordance with an operation of a manager.

5. The apparatus of claim 2, wherein:
the external device comprises a memory;
the circuitry is configured to:
acquire usage information comprising a second rate of usage of the memory provided in the external device;
determine whether the second rate of usage included in the acquired usage information exceeds a recommended second rate of usage; and
decide a memory capacity necessary for ensuring the second rate of usage of the memory in the external device to be less than or equal to the recommended second rate of usage when it is determined that the second rate of usage exceeds the second recommended rate of usage.

6. The apparatus of claim 5, wherein the circuitry further configured to set the second rate of usage in accordance with an operation of a manager.

7. The apparatus of claim 2, wherein:
the external device comprises a disk storage;
the circuitry is further configured to:
acquire usage information comprising third free space of the disk storage provided in the external device;
determine whether the third free space included in the acquired usage information is less than recommended third free space; and
decide a capacity of a disk storage necessary for ensuring free space of the disk storage in the external device to be greater than or equal to the recommended third free space when it is determined that the third free space is less than the recommended third free space.

8. The apparatus of claim 7, wherein the circuitry is further configured to set the third free space in accordance with an operation of a manager.

9. The apparatus of claim 8, wherein the circuitry is further configured to set the third free space according to an operating system of the external device.

10. The apparatus of claim 1, wherein the circuitry is further configured to:
search for devices and/or products corresponding to the configuration of the external device based on the usage; and
recommend at least one searched device and/or a searched product.

11. The apparatus of claim 10, wherein the circuitry is further configured to recommend a product with a priority to the lowest price among the searched products.

12. The apparatus of claim 1, wherein the circuitry is further configured to recommend a device and/or a configuration of the external device based on the usage information and a recommended software environment of the external device.

13. A method executed by an electronic apparatus comprising:
acquiring usage information indicative of use of a device in an external device; and
determining a recommended device and/or a recommended configuration of the external device based on the acquired usage information.

14. A non-transitory computer-readable storage medium having stored a computer program which is executable by a computer, the computer program comprising instructions capable of causing the computer to execute functions of:
acquiring usage information indicative of use of a device in an external device; and
determining a recommended device or a recommended configuration of the external device based on the acquired usage information.
